(19) United States
(12) Patent Application Publication
(10) Pub. No.: US 2016/0131326 A1
(43) Pub. Date: May 12, 2016

(54) Foldable Lampshade

(71) Applicant: Mospen Products Company, Taipei City (TW)

(72) Inventor: Chason Yen, Taipei City (TW)

(21) Appl. No.: 14/536,690

(22) Filed: Nov. 10, 2014

(51) Int. Cl. F21V 1/06; F21V 1/12

(52) U.S. Cl. CPC F21V 1/06; F21V 1/12

(57) ABSTRACT

A foldable lampshade includes a cover with a first opening at the top and a second opening at the bottom, a first frame contained in the first opening and a second frame contained in the second opening. Plural support rods are extended towards the center of the first frame, and the other end is extended towards the center and coupled to a fixing ring at the center. A sheath member is installed at a joint of each support rod connected to the first frame. The second frame includes plural moving rods corresponsive to the sheath members respectively, so that after each moving rod is swung, the other end of the moving rod is latched into each sheath member for supporting and erecting the cover. Therefore, the volume of the folded lampshade can be reduced to lower the packaging and transportation costs.

### BACKGROUND OF THE INVENTION

1. Field of the Invention

The present invention relates to the field of illumination devices, and more particularly to the structure of a foldable lampshade that can be installed to a floor lamp or a table lamp for the purpose of providing decoration and soft light effects, and the volume of the foldable lampshade can be reduced effectively for storage and transportation, so as to reduce the transportation cost.

2. Description of the Related Art

In general, illumination lamps are divided into wall lamps, floor lamps and table lamps according to their usage. Regardless of a light source being a light bulb or an LED bulb, our eyes are dazzled by the light source, so that a lampshade is required to soften the brightness and light color of the lamp. Further, the lampshade may come with a stylish design or a pattern printed on the lampshade to enhance the overall appearance of the lamp. In general, the lampshade is a fixed cylindrical structure, so that the heat generated by the lamp can be dissipated easily. However, such lampshade has a large volume which is not conducive to transportation or storage. In addition, the lampshades may be collided with each other and damaged, and these problems incur a higher cost and require a feasible solution.

Hence, a modular lampshade was introduced. With reference to FIG. 1 for a schematic view of a conventional modular lampshade, the modular lampshade 1 comprises an upper frame 11, a lower frame 12 and a hood 13, wherein the hood 13 is disposed around the external periphery of the upper frame 11 and lower frame 12, and the hood 13 has two openings, and the two openings include a plurality of first latch members 131 and a plurality of second latch members 132 detachably latched with the upper frame 11 and the lower frame 12 respectively, so that the hood 13, the upper frame 11 and the lower frame 12 can be fixed to form a 3D lampshade. Since the first latch members 131 and the second latch members 132 are not connected or interfered with each other, therefore the hood may be bent with a more flexible curvature. In other words, even if the upper frame 11 and the lower frame 12 are in a polygonal shape or any other shape, the first latch members 131 and the second latch members 132 are latched securely to the upper frame 11 and the lower frame 12, and will not be separated from the hood 13 when the curvature of the upper frame 11 and the lower frame 12 is too large.

However, the major drawback of this kind of modular lampshades 1 resides on that the hood 13 being made of a hard translucent material, so that the lampshades can be folded slightly, and are unable to reduce the volume or prevent the first latch member 131 and the second latch members 132 from rubbing with each other or damaging the hood 13.

In view of the problems of the prior art, the inventor of the present invention designed and developed a foldable lampshade having a flexible and translucent cover, a first frame and a second frame contained two openings of the cover respectively, a plurality of sheath members installed at the first frame, for latching and fixing a plurality of moving rods of the second frame to form a 3D lampshade. The invention provides a convenient operation and achieves the effects of saving the packaging volume, packing materials, and transportation and warehouse and storage costs.

### SUMMARY OF THE INVENTION

In view of the aforementioned problems of the prior art, it is a primary objective of the present invention to provide a foldable lampshade with a special design of a first frame and a second frame, and a cover made of a flexible and translucent material to achieve the effects of supporting and erecting the cover quickly, and reducing the storage volume of the folded lampshade to lower the packaging, transportation and warehouse and storage costs.

To achieve the aforementioned objective, the present invention provides a foldable lampshade, comprising: a cover, being a hollow tubular structure made of a flexible and translucent material, and having a first opening formed at the top of the cover and a second opening formed at the bottom of the cover; a first frame, being a frame structure in the shape corresponsive to the first opening, and contained in the first opening, and having a plurality of support rods extended towards the center of the first frame, and the other end of each support rod being extended towards the center and coupled to a fixing ring disposed at the center, and a sheath member being installed at a joint of each support rod connected to the first frame having; and a second frame, being a frame structure in the shape corresponsive to the second opening and contained in the second opening, and having a plurality of moving rods with a quantity equal to the quantity of the sheath members, so that the position of each moving rod is corresponsive to the position of each sheath member, and after each moving rod is swung, the other end of the moving rod is latched into each sheath member for supporting and erecting the cover vertically to form a three-dimensional lampshade structure.

In an embodiment, both of the first frame and the second frame are in a circular shape, and the quantity of support rods is equal to three, and the support rods are installed at equally spaced points of the first frame respectively, so that the two adjacent support rods have an included angle of 120 degrees, and the quantity of moving rods is also equal to three, and the three moving rods are installed at equally spaced points of the second frame respectively, and the two adjacent moving rods have an included angle of 120 degrees. Therefore, the foldable lampshade is support and formed into a cylindrical lampshade structure.

In another embodiment, both of the first frame and the second frame are in a rectangular shape, and the quantity of support rods is equal to four, and the four support rods are installed at four corners of the first frame respectively, and the quantity of moving rods is also equal to four, and the four moving rods are installed at four corners of the second frame respectively. Therefore, the foldable lampshade is supported and formed into a rectangular lampshade structure.

In addition, the cover is made of a material selected from the collection of cotton cloth, hemp cloth, artificial fiber cloth and translucent paper, so that the cover can be cleaned, rinsed and maintained easily, and the sheath member is an inverted U-shaped structure slightly and inwardly retracted from an opening to form a clamping section for latching each moving rod.

### BRIEF DESCRIPTION OF THE DRAWINGS

FIG. 1 is a schematic view of a conventional modular lampshade;

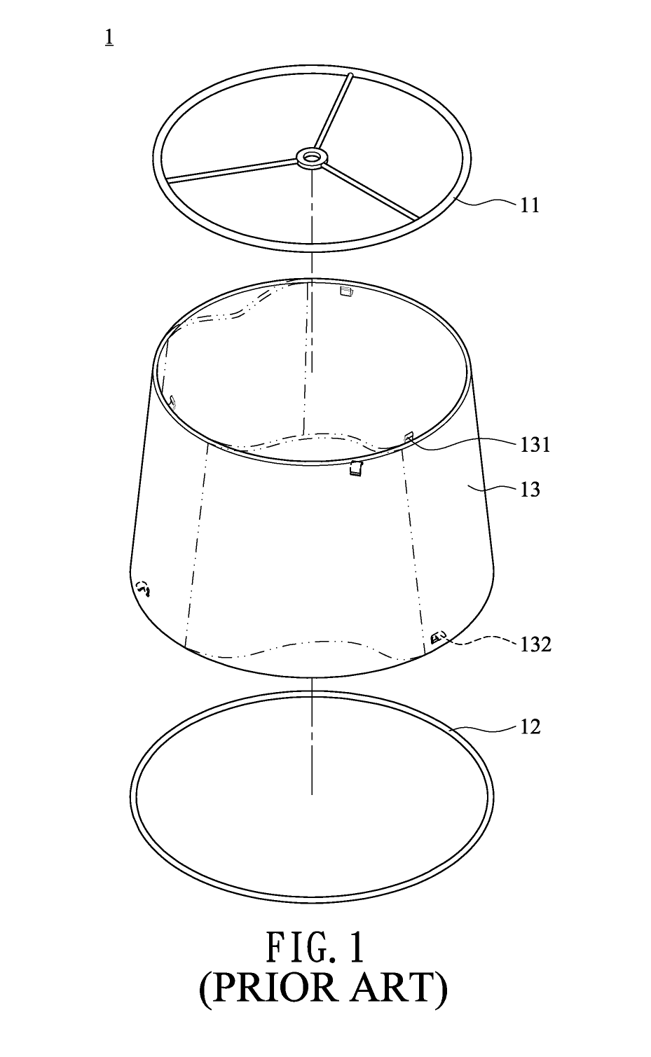

FIG. 2 is an exploded view of a preferred embodiment of the present invention;

FIG. 3 is a perspective view of a preferred embodiment of the present invention;

FIG. 4 is a schematic view showing a storage status of a preferred embodiment of the present invention;

FIG. 5 is a schematic view of an unfolded status of a preferred embodiment of the present invention;

FIG. 6 is an exploded view of another preferred embodiment of the present invention; and

FIG. 7 is a perspective view of another preferred embodiment of the present invention.

### DETAILED DESCRIPTION OF THE PREFERRED EMBODIMENTS

The aforementioned and other objectives, technical characteristics and advantages of the present invention will become apparent with the detailed description of preferred embodiments and the illustration of related drawings as follows.

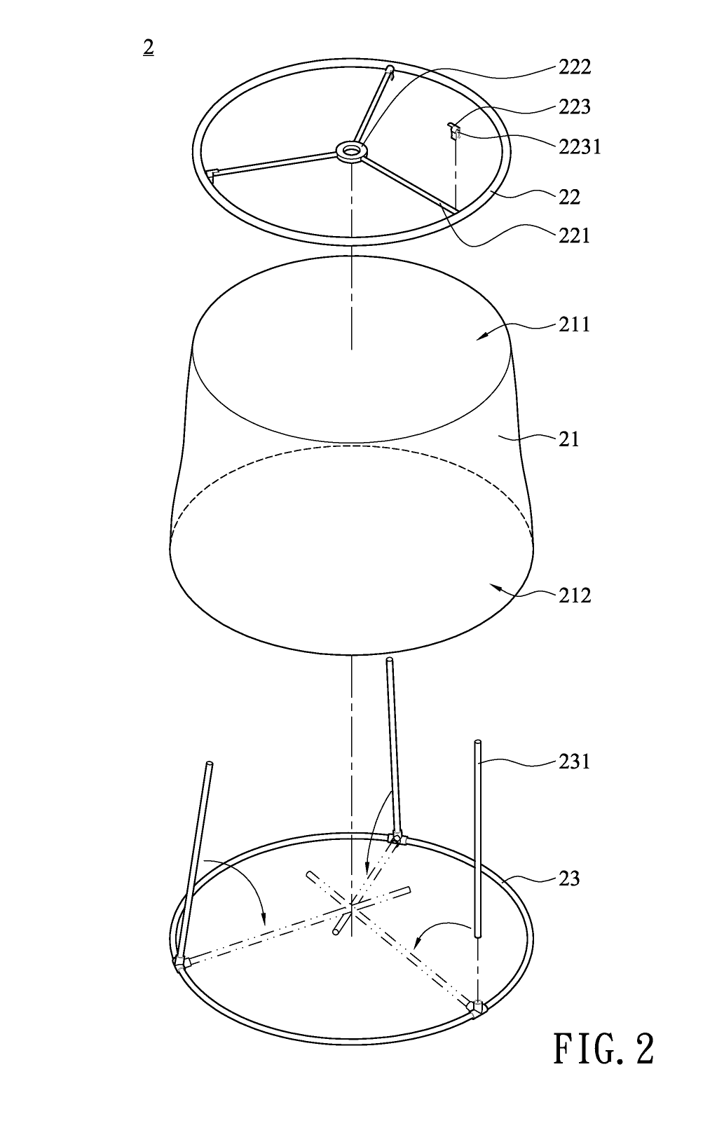

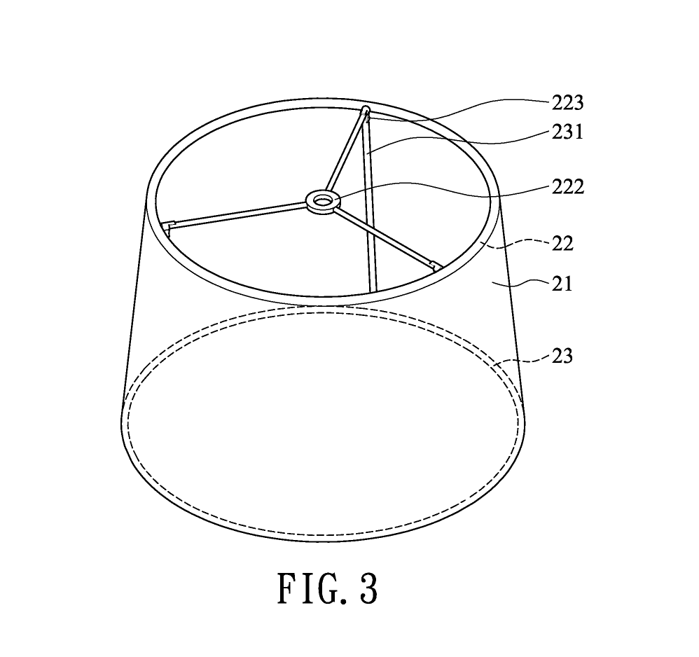

With reference to FIGS. 2 to 5 for an exploded view and a perspective view of a foldable lampshade and schematic views of different operating statuses in accordance with a preferred embodiment of the present invention respectively, the foldable lampshade 2 comprises a cover 21, a first frame 22 and a second frame 23.

The cover 21 is a hollow circular tubular structure made of a flexible and translucent material such as cotton cloth, hemp cloth, artificial fiber cloth or translucent paper. The cover 21 includes a first opening 211 formed at the top and a second opening 212 formed at the bottom.

The first frame 22 is a circular frame structure in a shape corresponsive to the first opening 211 and contained in the first opening 211, and three support rods 221 are extended towards the center of the first frame 22 and installed at equally spaced points of the first frame 22 respectively, so that the two adjacent support rods 221 have an included angle of 120 degrees, and the other end of each support rod 221 is extended towards the center and coupled to a fixing ring 222 disposed at the center, and a sheath member 223 is installed at a joint of each support rod 221 connected to the first frame 22, wherein the sheath member 223 is an inverted U-shaped structure which is inwardly retracted from an opening to form a clamping section for latching each moving rod.

The second frame 23 is a circular frame structure in a shape corresponsive to the second opening 212 and contained in the second opening 212. The quantity of second frames 23 is equal to the quantity of sheath members 223, and there are three moving rods 231 installed at equally spaced points of the second frame 23 respectively, so that two adjacent moving rods 231 have an included angle of 120 degrees. The position of each moving rod 231 is corresponsive to the position of each respective sheath member 223, so that after each moving rod 231 is swung, the other end of the moving rod 231 is latched into the clamping section 2231 of each sheath member 223 for supporting and erecting the cover 21 to form a three-dimensional lampshade structure.

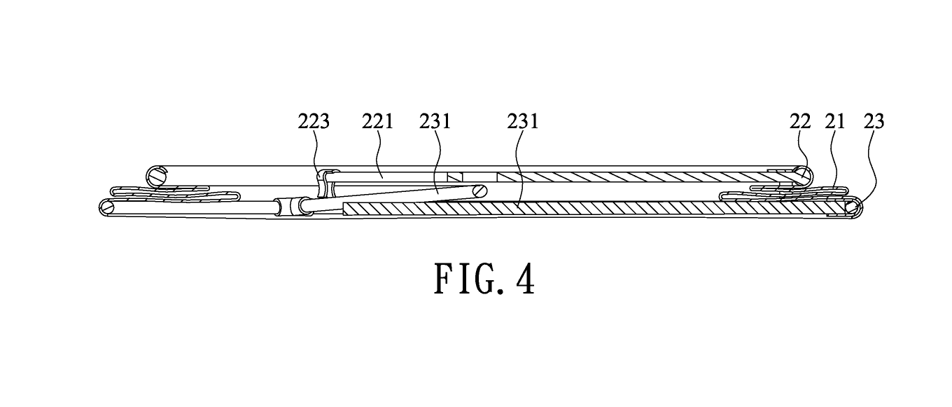

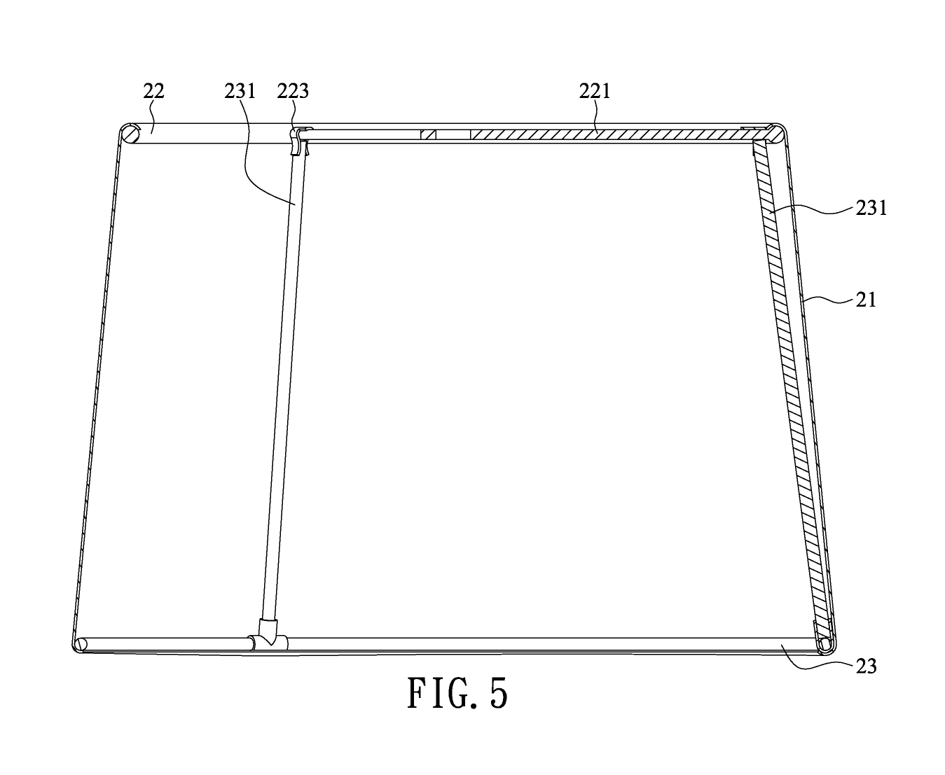

In FIG. 4, if a user wants to store the foldable lampshade 2, the user simply moves the moving rods 231 towards the center to separate an end of each moving rod 231 from the respective sheath member 223, and then stack the moving rods 231 with each other. Now, the cover 21 no longer has the support, and thus the first opening 211 is moved towards the second opening 212 to achieve the folding and storing effects. In FIG. 5, if the user wants to unfold the foldable lampshade 2, the user simply moves the moving rods 231 towards the outside to latch their ends to the sheath members 223 again, and the cover 21 is supported and erected again to form a three-dimensional lampshade structure. The operation is very simple and easy, and the lampshade can be folded without the need of storing or hiding the first frame 22 and the second frame 23. Obviously, the present invention provides a very convenient way of storing a lampshade.

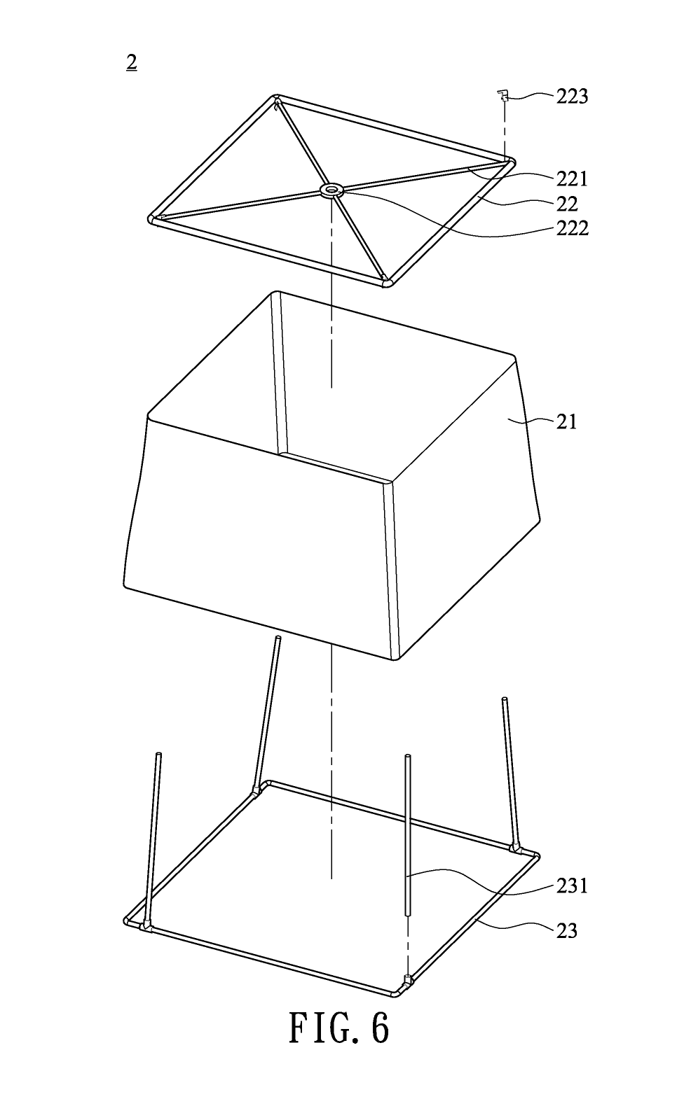

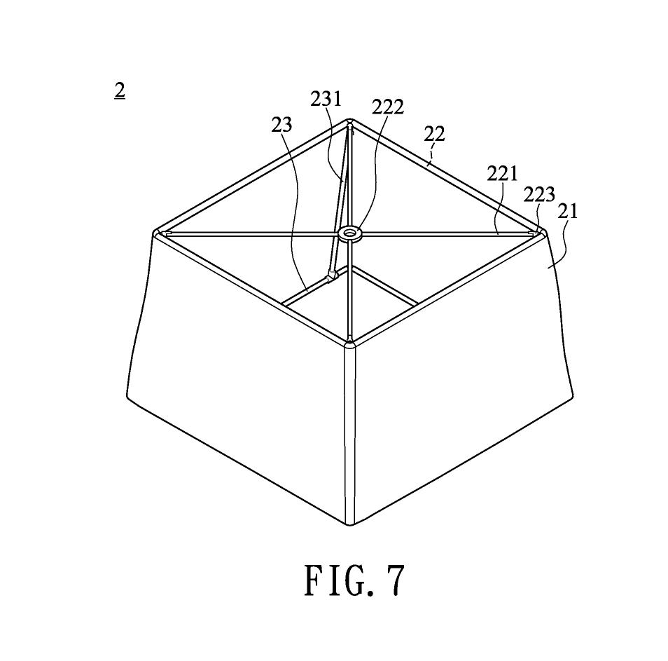

With reference to FIGS. 6 and 7 for an exploded view and a perspective view of another preferred embodiment of the present invention respectively, the first frame 22 and the second frame 23 are both in a rectangular shape, so that the cover 21 becomes a hollow tubular structure in the shape of a rectangular block, and the quantity of support rods 221 is equal to four and the four support rods 221 are installed at four corners of the first frame 22 respectively, and each support rod 221 is extended towards the center and coupled to the fixing ring 222. Therefore, the top view shows that the lampshade is X-shaped. Similarly, the quantity of moving rods 231 is equal to four and the four moving rods 231 are installed at four corners of the second frame 23 respectively. The operating method of this embodiment is the same as that of the previous embodiment, and thus will not be repeated.

What is claimed is:

1. A foldable lampshade, comprising:
a cover, being a hollow tubular structure made of a flexible and translucent material, and having a first opening formed at the top of the cover and a second opening formed at the bottom of the cover;
a first frame, being a frame structure in the shape corresponsive to the first opening, and contained in the first opening, and having a plurality of support rods extended towards the center of the first frame, and the other end of each support rod being extended towards the center and coupled to a fixing ring disposed at the center, and a sheath member being installed at a joint of each support rod connected to the first frame having; and
a second frame, being a frame structure in the shape corresponsive to the second opening and contained in the second opening, and having a plurality of moving rods with a quantity equal to the quantity of the sheath members, so that the position of each moving rod is corresponsive to the position of each sheath member, and after each moving rod is swung, the other end of the moving rod is latched into each sheath member for supporting and erecting the cover vertically to form a three-dimensional lampshade structure.

2. The foldable lampshade of claim 1, wherein both of the first frame and the second frame are in a circular shape, and the quantity of support rods is equal to three, and the support rods are installed at equally spaced points of the first frame respectively, so that the two adjacent support rods have an included angle of 120 degrees, and the quantity of moving rods is also equal to three, and the three moving rods are installed at equally spaced points of the second frame respectively, and the two adjacent moving rods have an included angle of 120 degrees.

3. The foldable lampshade of claim 1, wherein both of the first frame and the second frame are in a rectangular shape, and the quantity of support rods is equal to four, and the four support rods are installed at four corners of the first frame respectively, and the quantity of moving rods is also equal to four, and the four moving rods are installed at four corners of the second frame respectively.

4. The foldable lampshade of claim 2, wherein the cover is made of a material selected from the collection of cotton cloth, hemp cloth, artificial fiber cloth and translucent paper.

5. The foldable lampshade of claim 3, wherein the cover is made of a material selected from the collection of cotton cloth, hemp cloth, artificial fiber cloth and translucent paper.

6. The foldable lampshade of claim 2, wherein the sheath member is an inverted U-shaped structure slightly and inwardly retracted from an opening to form a clamping section for latching each moving rod.

7. The foldable lampshade of claim 3, wherein the sheath member is an inverted U-shaped structure slightly and inwardly retracted from an opening to form a clamping section for latching each moving rod.
